(19) United States
(12) Patent Application Publication
(10) Pub. No.: US 2008/0001975 A1
(43) Pub. Date: Jan. 3, 2008

(54) Image processing apparatus and image processing method

(76) Inventor: Eiki Obara, Hiki-gun (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/821,997

(22) Filed: Jun. 25, 2007

(30) Foreign Application Priority Data
Jun. 30, 2006 (JP) 2006-182192

(51) Int. Cl. G09G 5/02; G06K 9/36; H04N 7/12

(52) U.S. Cl. 345/694; 345/600; 375/240.01; 382/232; 375/E07.04

(57) ABSTRACT

According to one embodiment, an image processing apparatus divides the input image data into a plurality of first blocks, and calculates four mean pixel values corresponding to four second blocks which have central regions located at four corners of the first block to be processed. The apparatus replaces pixel values of four pixels, which are located at the four corners of the first block to be processed, with the four mean pixel values. The apparatus calculates substitute pixel values corresponding to pixels in the first block to be processed, on the basis of the replaced pixel values of the four pixels, and replaces pixel values of the pixels in the first block to be processed with the corresponding substitute pixel values calculated.

### CROSS-REFERENCE TO RELATED APPLICATIONS

This application is based upon and claims the benefit of priority from Japanese Patent Application No. 2006-182192, filed Jun. 30, 2006, the entire contents of which are incorporated herein by reference.

### BACKGROUND

1. Field

One embodiment of the present invention relates to an image processing apparatus and an image processing method for generating output image data, which is to be output to a display device, from input image data.

2. Description of the Related Art

In general, in most of personal computers, an internal signal process for generating image data is performed with 8 bits for each of R, G and B, but display data which is to be output to a display is limited to 6 bits for each of R, G and B. Thus, in a display controller provided within a computer, dithering is performed using the reduced two bits. Thereby, for each of R, G and B, an 8-bit equivalent pseudo-gradation number (number of gradations=256) is realized.

In addition, in some types of digital TV receivers, the digital signal process is executed with 10 bits for each of R, G and B, but display data which is to be output to the display is limited to 8 bits for each of R, G and B. In this case, in the digital TV receiver, frame rate control (FRC) is executed on the basis of the reduced two bits, and thereby a 10-bit equivalent pseudo-gradation number (number of gradations=1024) is realized.

Dithering and frame rate control (FRC) are well known as techniques for expressing a great number of colors with a less number of bits.

Jpn. Pat. Appln. KOKAI Publication No. 2005-84516 discloses a technique in which a gradation number, which is expressed by high-order 6 bits, is converted to an 8-bit equivalent pseudo-gradation number (number of gradations=256) by the dithering using the lower-order 2 bits.

However, even if the dithering or frame rate control (FRC) is used, a contour-line-like stripe pattern, which is called “contouring”, and minute noise tend to easily occur due to roughness of quantization in an image with a gently varying gradation level.

It is thus necessary to realize a novel image processing technique capable of making less visible a stripe pattern (contouring) and minute noise in an image region with a gently varying gradation level.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing an example of the structure of an image processing apparatus according to an embodiment of the invention;

FIG. 2 is an exemplary view showing a state in which whole image data is divided into a plurality of first blocks by the image processing apparatus according to the embodiment;

FIG. 3 is an exemplary view showing an example of a second block (macro-block) having a central region located at the upper left corner of the first block to be processed;

FIG. 4 is an exemplary view showing an example of the second block (macro-block) having a central region located at the lower left corner of the first block to be processed;

FIG. 5 is an exemplary view showing an example of the second block (macro-block) having a central region located at the upper right corner of the first block to be processed;

FIG. 6 is an exemplary view showing an example of the second block (macro-block) having a central region located at the lower right corner of the first block to be processed;

FIG. 7 is an exemplary view for explaining substitute pixel values corresponding to four-corner pixels of the first block to be processed;

FIG. 8 is an exemplary view for explaining a substitute pixel value calculation process for vertical pixel strings, which is executed by the image processing apparatus according to the embodiment;

FIG. 9 is an exemplary view for explaining a substitute pixel value calculation process for horizontal pixel strings, which is executed by the image processing apparatus according to the embodiment;

FIG. 10 is an exemplary block diagram showing an example of the structure of a computer to which the image processing apparatus according to the present embodiment is applied;

FIG. 11 is an exemplary block diagram showing an example of the structure of a TV receiver to which the image processing apparatus according to the present embodiment is applied;

FIG. 12 is an exemplary block diagram showing an example of the concrete structure of the image processing apparatus according to the present embodiment in the case where the image processing apparatus is applied to the computer;

FIG. 13 is an exemplary block diagram showing an example of the concrete structure of the image processing apparatus according to the present embodiment in the case where the image processing apparatus is applied to the TV receiver;

FIG. 14 is an exemplary view showing an example of a pixel arrangement, which is used in the image processing apparatus according to the present embodiment;

FIG. 15 is an exemplary view showing a manner in which four-corner pixels of the first block to be processed are replaced by the image processing apparatus according to the present embodiment;

FIG. 16 is an exemplary view showing an example of a dithering table which is used in the image processing apparatus according to the present embodiment;

FIG. 17 is an exemplary view showing a relationship between the dithering table shown in FIG. 16 and pixel positions;

FIG. 18 is an exemplary view showing an example of the dithering table which varies from frame to frame, the dithering table being used in the image processing apparatus according to the present embodiment; and

FIG. 19 is an exemplary flowchart showing an example of the procedure of an image process which is executed by the image processing apparatus according to the present embodiment.

### DETAILED DESCRIPTION

Various embodiments according to the invention will be described hereinafter with reference to the accompanying drawings. In general, according to one embodiment of the invention, an image processing apparatus which generates output image data, which is to be output to a display device, from input image data, includes: a mean pixel value calculation unit which divides the input image data into a plurality of first blocks, and calculates four mean pixel values corresponding to four second blocks which have central regions located at four corners of the first block to be processed; a first replacement unit which replaces, if a difference value between a maximum pixel value and a minimum pixel value in each of the four second blocks is less than a first threshold value, pixel values of four, first to fourth, pixels, which are located at the four corners of the first block to be processed, with the four mean pixel values; a substitute pixel value calculation unit which calculates substitute pixel values corresponding to pixels in the first block to be processed, on the basis of the replaced pixel values of the four, first to fourth, pixels; and a second replacement unit which replaces, if a difference value between a maximum pixel value and a minimum pixel value in the first block to be processed is less than a second threshold value, pixel values of the pixels in the first block to be processed with the corresponding substitute pixel values calculated by the substitute pixel value calculation unit.

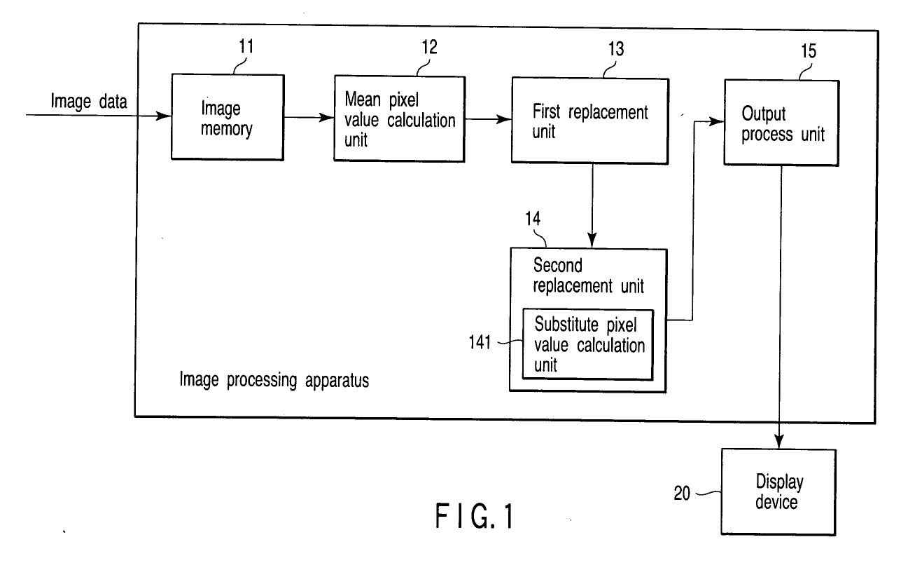

To begin with, referring to FIG. 1, the general structure of an image processing apparatus according to the embodiment of the invention is described. The image processing apparatus is an apparatus for executing various image processes for displaying image data on a display device 20. The image processing apparatus generates output image data, which is to be output to the display device 20, from input image data. This image processing apparatus is used in the state in which the image processing apparatus is mounted in, for instance, a personal computer or a digital TV receiver.

This image processing apparatus has a function of executing an image process for increasing the number of gradations of image data (this image process is also referred to as “gradation interpolation process”). As is shown in FIG. 1, the image processing apparatus includes an image memory 11, a mean pixel value calculation unit 12, a first replacement unit 13, a second replacement unit 14 and an output process unit 15.

The image memory 11 is a frame memory for temporarily storing image data to be displayed. The mean pixel value calculation unit 12 divides the image data to be displayed into a plurality of first blocks, and calculates, with respect to each first block, four mean pixel values (mean gradation levels) corresponding to four second blocks which have central regions located at the four corners of the first block.

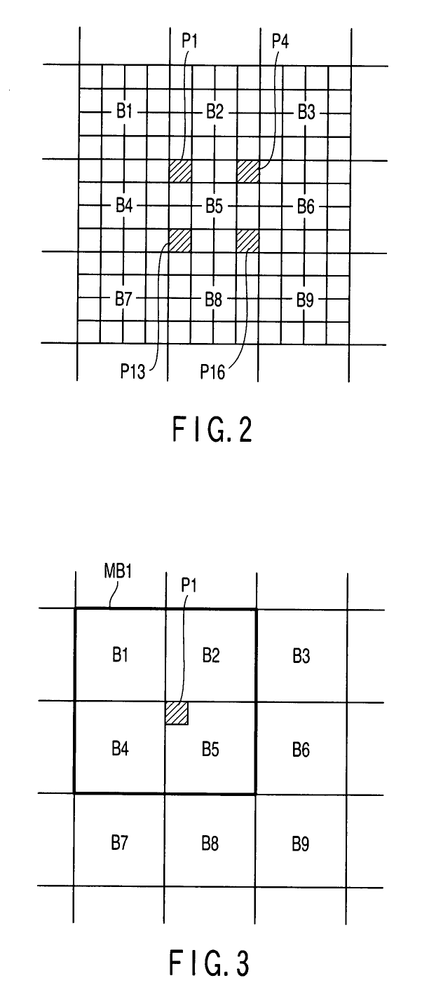

The first block is, for example, an area including the same number of pixels in vertical and horizontal directions. FIG. 2 shows an example in which the whole screen of image data is divided into a plurality of rectangular first blocks (blocks B1, B2, B3, B4, B5, B6, B7, B8, B9, . . . ) each having, e.g., 4×4 pixels.

If the first block to be process is a block B5, the mean pixel value calculation unit 12 defines four second blocks having their central regions located at the four corners of the block B5 (i.e., pixel positions of pixels P1, P13, P4 and P16), and calculates four mean pixel values corresponding to the four second blocks. Pixels P1 and P16 are positioned on a diagonal of the first block, and pixels P4 and P13 are positioned on another diagonal of the first block.

Each second block is an area including a plurality of pixels, and is formed of an area including a greater number of pixels than each first block. In the description below, it is assumed that each second block comprises four first blocks including at least a first block to be processed.

FIG. 3 shows an example of the second block (macro-block MB1) having a central region located at the upper left corner of the block B5. The macro-block MB1 comprises four first blocks B1, B2, B4 and B5.

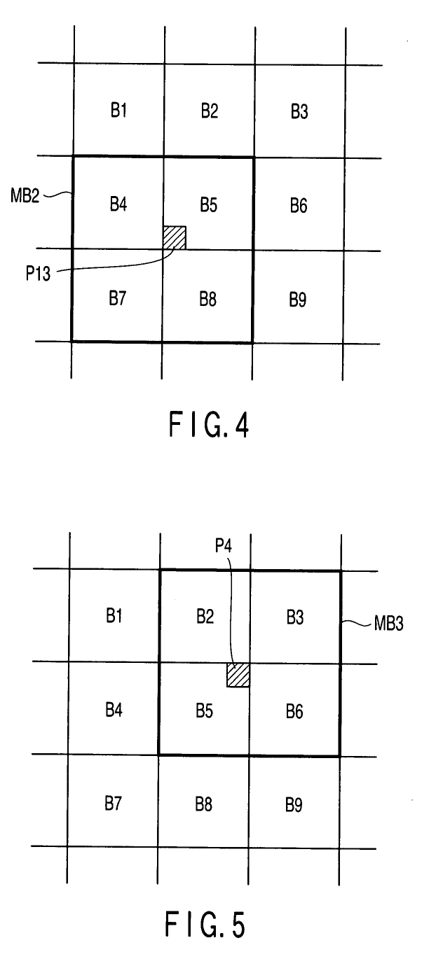

FIG. 4 shows an example of the second block (macro-block MB2) having a central region located at the lower left corner of the block B5. The macro-block MB2 comprises four first blocks B4, B5, B7 and B8.

FIG. 5 shows an example of the second block (macro-block MB3) having a central region located at the upper right corner of the block B5. The macro-block MB3 comprises four first blocks B2, B3, B5 and B6.

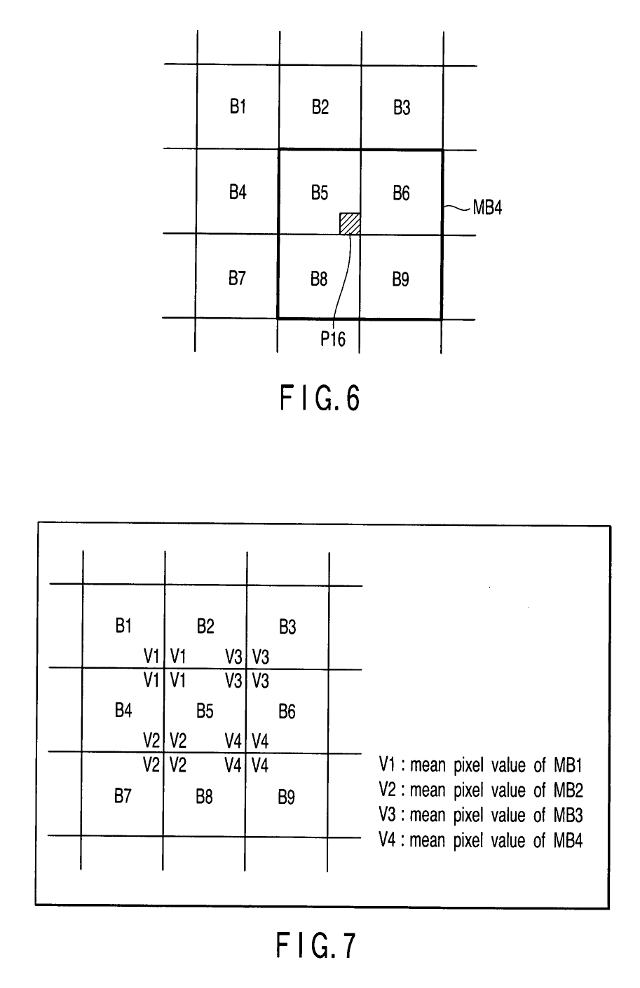

FIG. 6 shows an example of the second block (macro-block MB4) having a central region located at the lower right corner of the block B5. The macro-block MB4 comprises four first blocks B5, B6, B8 and B9.

The mean pixel value calculation unit 12 calculates a mean pixel value of the macro-block MB1 (blocks B1, B2, B4 and B5), a mean pixel value of the macro-block MB2 (blocks B4, B5, B7 and B8), a mean pixel value of the macro-block MB3 (blocks B2, B3, B5 and B6), and a mean pixel value of the macro-block MB4 (blocks B5, B6, B8 and B9).

The first replacement unit 13 shown in FIG. 1 executes a first pixel value replacement process with respect to each of the first blocks. In the first pixel value replacement process, the first replacement unit 13 replaces the pixel values of the four pixels (P1, P13, P4 and P16), which are located at the four corners of the first block (B5) to be processed, with the four mean pixel values (the mean pixel value of the macro-block MB1, the mean pixel value of the macro-block MB2, the mean pixel value of the macro-block MB3 and the mean pixel value of the macro-block MB4) calculated by the mean pixel value calculation unit 12.

FIG. 7 shows examples of substituted pixel values of the four pixels (P1, P13, P4 and P16) that are located at the four corners of the first block (B5) to be processed. In FIG. 7, the pixel values of the four pixels (P1, P13, P4 and P16) located at the four corners of the first block (B5) are replaced with V1, V2, V3 and V4, respectively. V1 indicates the mean pixel value of the macro-block MB1, V2 indicates the mean pixel value of the macro-block MB2, V3 indicates the mean pixel value of the macro-block MB3, and V4 indicates the mean pixel value of the macro-block MB4.

If the four macro-blocks corresponding to the four corners of the first block to be processed includes a macro-block with a large variation in pixel value (i.e., a macro-block in which a difference value between a maximum pixel value in the macro-block and a minimum pixel value in the macro-block is a specified first threshold value or more), the process of replacing the pixel value of one corner of the first block to be processed is not executed. For example, if a difference value between a maximum pixel value in the macro-block MB1 and a minimum pixel value in the macro-block MB1 is a specified first threshold value or more, the process of replacing the pixel value of pixel P1 with V1 is not executed. Accordingly, in the first pixel value replacement process, the process of replacing the pixel values of all the four pixels located at the four corners of the first block to be processed is executed in the case where the difference value between the maximum pixel value and minimum pixel value in each of the four macro-blocks MB1 to MB4 is less than the first threshold value.

The first pixel value replacement process is successively executed for all the first blocks.

Since a second block having a central region at the lower right corner of the block B1 is also the macro-block MB1 (blocks B1, B2, B4 and B5), the pixel value of the pixel at the lower right corner of the block B1 is also replaced with the mean pixel value V1 of the macro-block MB1 in the first pixel value replacement process.

Similarly, since a second block having a central region at the lower left corner of the block B2 is also the macro-block MB1 (blocks B1, B2, B4 and B5), the pixel value of the pixel at the lower left corner of the block B2 is also replaced with the mean pixel value V1 of the macro-block MB1 in the first pixel value replacement process.

Furthermore, since a second block having a central region at the upper right corner of the block B4 is also the macro-block MB1 (blocks B1, B2, B4 and B5), the pixel value of the pixel at the upper right corner of the block B4 is also replaced with the mean pixel value V1 of the macro-block MB1 in the first pixel value replacement process.

Thus, the pixel values of all the four pixels belonging to the central part of each macro-block are replaced with the mean pixel value of the macro-block.

For example, the pixel values of four pixels (the pixel at the lower right corner of the block B4, the pixel at the upper right corner of the block B7, the pixel at the lower left corner of the block B5 and the pixel at the upper left corner of the block B8), which belong to the central part of the macro-block MB2 (blocks B4, B5, B7 and B8), are replaced with the mean pixel value V2 of the macro-block MB2.

The pixel values of four pixels (the pixel at the lower right corner of the block B2, the pixel at the upper right corner of the block B5, the pixel at the lower left corner of the block B3 and the pixel at the upper left corner of the block B6), which belong to the central part of the macro-block MB3 (blocks B2, B3, B5 and B6), are replaced with the mean pixel value V3 of the macro-block MB3.

The pixel values of four pixels (the pixel at the lower right corner of the block B5, the pixel at the upper right corner of the block B8, the pixel at the lower left corner of the block B6 and the pixel at the upper left corner of the block B9), which belong to the central part of the macro-block MB4 (blocks B5, B6, B8 and B9), are replaced with the mean pixel value V4 of the macro-block MB4.

The second replacement unit 14 shown in FIG. 1 executes a second pixel value replacement process for each of the first blocks. In the second pixel value replacement process, the second replacement unit 14 calculates, on the basis of the substitute pixel values (V1, V2, V3 and V4) of the four, first to fourth, pixels (P1, P13, P4 and P16) located at the four corners of the first block (e.g., block B5) to be processed, substitute pixel values of the other pixels in the first block (B5) to be processed, excluding the four (first to fourth) pixels (P1, P13, P4 and P16). The second replacement unit 14 replaces the pixel values of the other pixels with the calculated corresponding substitute pixel values.

The four pixels (P1, P13, P4 and P16) may include a pixel whose pixel value has not been replaced. As regards the pixel whose pixel value has not been replaced, the original pixel value of this pixel is used in the second pixel value replacement process.

In the second pixel value replacement process, the calculation of the substitute pixel value for each pixel is executed by a substitute pixel value calculation unit 141 in the second replacement unit 14. On the basis of the positional relationship between the pixels, which are other than the four (first to fourth) pixels (P1, P13, P4 and P16), on the one hand, and the four (first to fourth) pixels (P1, P13, P4 and P16), on the other hand, the substitute pixel value calculation unit 141 calculates the substitute pixel values of the other pixels from the substitute pixel values (V1, V2, V3 and V4) of the four (first to fourth) pixels (P1, P13, P4 and P16).

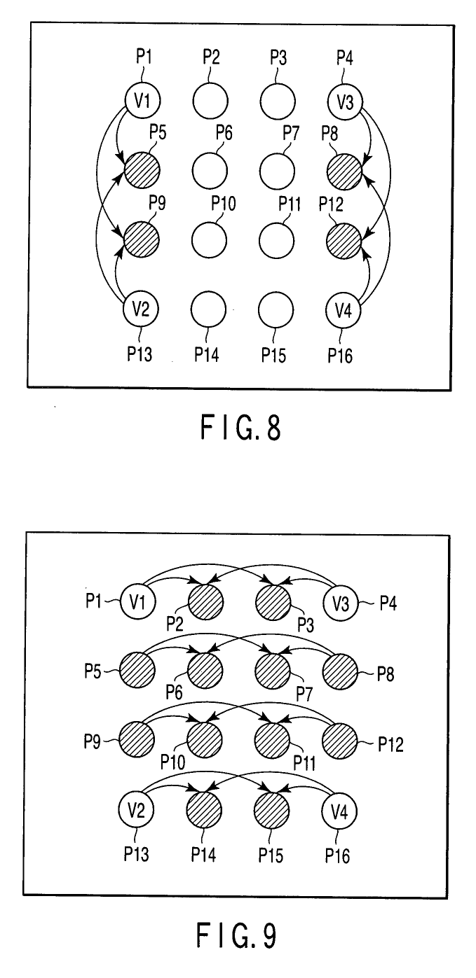

Referring now to FIGS. 8 and 9, an example of the substitute pixel value calculation process is explained.

As is shown in FIG. 8, the substitute pixel value calculation unit 141 first performs weighted averaging between the substitute pixel value (V1) of the first pixel (P1) and the substitute pixel value (V2) of the second pixel (P13), thereby calculating substitute pixel values of pixels (P5, P9) in a first pixel string (P5, P9) which is disposed between the first pixel (P1) and second pixel (P13). In this case, in the weighted averaging arithmetic operation for calculating the substitute pixel value of pixel P5, use is made of a first weighting coefficient which is inversely proportional to an inter-pixel distance between pixels P1 and P5, and a second weighting coefficient which is inversely proportional to an inter-pixel distance between pixels P13 and P5.

Similarly, in the weighted averaging arithmetic operation for calculating the substitute pixel value of pixel P9, a weighted mean value between V1 and V2 is calculated by using a first weighting coefficient which is inversely proportional to an inter-pixel distance between pixels P1 and P9, and a second weighting coefficient which is inversely proportional to an inter-pixel distance between pixels P13 and P9.

Subsequently, the substitute pixel value calculation unit 141 performs weighted averaging between the substitute pixel value (V3) of the third pixel (P4) and the substitute pixel value (V4) of the fourth pixel (P16), thereby calculating substitute pixel values of pixels (P8, P12) in a second pixel string (P8, P12) which is disposed between the third pixel (P4) and fourth pixel (P16). In the weighted averaging arithmetic operation for calculating the substitute pixel value of pixel P8, a weighted mean value between V3 and V4 is calculated by using a first weighting coefficient which is inversely proportional to an inter-pixel distance between pixels P4 and P8, and a second weighting coefficient which is inversely proportional to an inter-pixel distance between pixels P16 and P8. Similarly, in the weighted averaging arithmetic operation for calculating the substitute pixel value of pixel P12, a weighted mean value between V3 and V4 is calculated by using a first weighting coefficient which is inversely proportional to an inter-pixel distance between pixels P4 and P12, and a second weighting coefficient which is inversely proportional to an inter-pixel distance between pixels P16 and P12.

Thereafter, as shown in FIG. 9, the substitute pixel value calculation unit 141 performs weighted averaging between the substitute pixel value (V1) of the first pixel (P1) and the substitute pixel value (V3) of the third pixel (P4), thereby calculating substitute pixel values of pixels (P2, P3) in a third pixel string (P2, P3) which is disposed between the first pixel (P1) and third pixel (P4). In the weighted averaging arithmetic operation for calculating the substitute pixel value of pixel P2, a weighted mean value between V1 and V3 is calculated by using a first weighting coefficient which is inversely proportional to an inter-pixel distance between pixels P1 and P2, and a second weighting coefficient which is inversely proportional to an inter-pixel distance between pixels P4 and P2. Similarly, in the weighted averaging arithmetic operation for calculating the substitute pixel value of pixel P3, a weighted mean value between V1 and V3 is calculated by using a first weighting coefficient which is inversely proportional to an inter-pixel distance between pixels P1 and P3, and a second weighting coefficient which is inversely proportional to an inter-pixel distance between pixels P4 and P3.

Subsequently, the substitute pixel value calculation unit 141 performs weighted averaging between the substitute pixel value (V2) of the second pixel (P13) and the substitute pixel value (V4) of the fourth pixel (P16), thereby calculating substitute pixel values of pixels (P14, P15) in a fourth pixel string (P14, P15) which is disposed between the second pixel (P13) and fourth pixel (P16). In the weighted averaging arithmetic operation for calculating the substitute pixel value of pixel P14, a weighted mean value between V2 and V4 is calculated by using a first weighting coefficient which is inversely proportional to an inter-pixel distance between pixels P13 and P14, and a second weighting coefficient which is inversely proportional to an inter-pixel distance between pixels P16 and P14. Similarly, in the weighted averaging arithmetic operation for calculating the substitute pixel value of pixel P15, a weighted mean value between V2 and V4 is calculated by using a first weighting coefficient which is inversely proportional to an inter-pixel distance between pixels P13 and P15, and a second weighting coefficient which is inversely proportional to an inter-pixel distance between pixels P16 and P15.

The substitute pixel value calculation unit 141 calculates substitute pixel values of the pixels in each of fifth pixel strings (a pixel string including pixels P6 and P7 and a pixel string including pixels P10 and P11), which are disposed between the first pixel string (P5, P9) and the second pixel string (P8, P12) and extend perpendicular to the first pixel string (P5, P9), by performing weighted averaging between the substitute pixel value of the associated pixel in the first pixel string and the substitute pixel value of the associated pixel in the second pixel string. For example, the substitute pixel value of each of pixels P6 and P7 is obtained by performing weighted averaging between the substitute pixel value of pixel P5 and the substitute pixel value of pixel P8. On the other hand, the substitute pixel value of each of pixels P10 and P11 is obtained by performing weighted averaging between the substitute pixel value of pixel P9 and the substitute pixel value of pixel P12.

The second pixel value replacement process by the second replacement unit 14 is executed only in the case where a difference value between a maximum pixel value and a minimum pixel value in the first block to be processed is less than a predetermined second threshold value. If the difference value is the second threshold value or more, the second pixel value replacement process is not executed. Thus, if the first block to be processed is a block including, e.g., graphic pattern, the second pixel value replacement process is not executed.

The output process unit 15 shown in FIG. 1 displays the image data, which is obtained by the above-described processes, on the display device 20.

As has been described above, in the image processing apparatus according to the present embodiment, in each first block to be processed, the pixel values of the four, first to fourth, pixels located at the four corners of the first block are replaced with four mean pixel values corresponding to the four second blocks having their central regions located at the four corners of the first block. On the basis of the replaced pixel values (post-replacement substitute pixel values) of the four (first to fourth) pixels, substitute pixel values for the other pixels in the first block to be processed are obtained.

Hence, the pixel values of the pixels in the first block can be determined so as to have gently varying gradation levels, in consideration of the pixel values of pixels which are present around the first block to be processed. Therefore, it becomes possible to make less visible the stripe pattern (contouring) and minute noise occurring in an image region with a gently varying gradation level, while avoiding such a problem that noise occurs at boundaries between the first blocks.

If each pixel of image data is composed of RGB data, the image process according to the present embodiment may be executed individually for each of R, G and B.

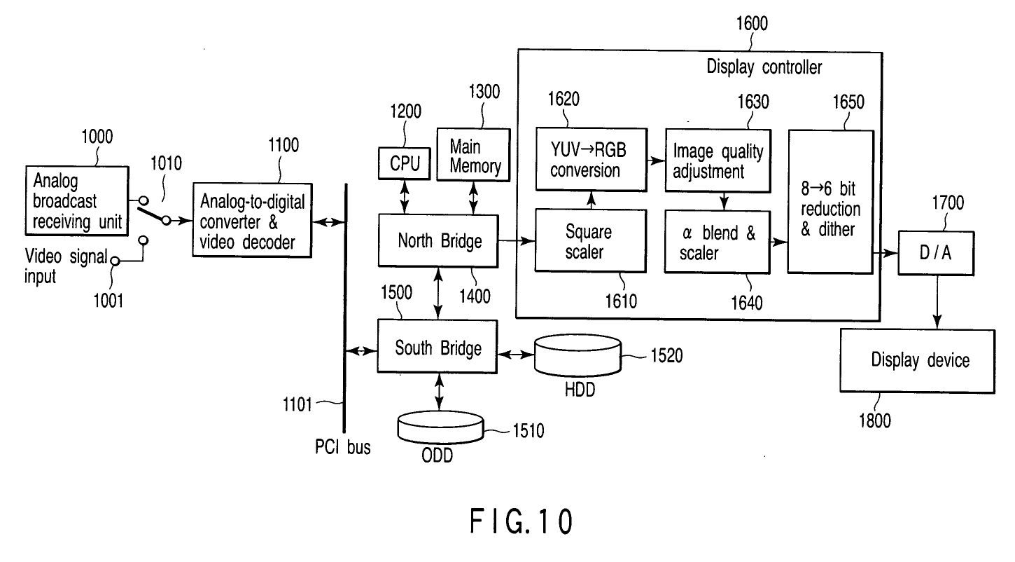

Next, referring to FIG. 10, a description is given of the flow of image data in a computer to which the image processing apparatus of the present embodiment is applied.

The computer includes an analog broadcast receiving unit 1000, an external video signal input unit 1001, a switch 1010, an analog-to-digital conversion & video decoder circuit 1100, a PCI bus 1101, a CPU 1200, a main memory 1300, a north bridge 1400, a south bridge 1500, an optical disc drive (ODD) 1510, a hard disk drive (HDD) 1520, a display controller 1600, a digital-to-analog converter 1700, and a display device 1800.

In the description below, it is assumed that a video signal, which is received by the analog broadcast receiving unit 1000, or a video signal, which is input from outside to the external video signal input unit 1001, is to be displayed on the display device 1800.

The switch 1010 selects one of a video signal included in a broadcast signal which is received by the analog broadcast receiving unit 1000, and a video signal which is input from outside to the external video signal input unit 1001. The selected video signal is delivered to the analog-to-digital & video decoder circuit 1100. The analog-to-digital & video decoder circuit 1100 converts the input video signal to a YUV-format baseband signal (digital image data). The image data obtained by the analog-to-digital & video decoder circuit 1100 is transferred to the main memory 1300 via the PCI bus 1101, south bridge 1500 and north bridge 1400. Software, which is executed by the CPU 1200, carries out various image processes, as needed, on the image data that is stored in the main memory 1300. Then, the image data is sent from the main memory 1300 to the display controller 1600 by the CPU 1200.

The display controller 1600 generates display data, which is to be output to the display device 1800, from the input image data. In the display controller 1600, the image data is first delivered to a square scaler circuit 1610. In the square scaler circuit 1610, the pixel shape of the image data is adjusted. Subsequently, the image data is converted from YUV data to RGB data by a YUV→RGB conversion circuit 1620. The RGB data is composed of, e.g., 24 bits per pixel (8 bits for each of R, G and B). After the image quality balance of the RGB-format image data is adjusted by an image quality adjusting circuit 1630, the image data is sent to an α blend & scale circuit 1640. The α blend & scale circuit 1640 executes a scaling process for changing the size of the image data to a screen size of the display device 1800. The scaled image data is sent to an 8→6-bit reduction & dither circuit 1650. In the 8→6-bit reduction & dither circuit 1650, the image data is converted from the data format of 8 bits for each of R, G and B per pixel to a data format of 6 bits for each of R, G and B, and then subjected to a dithering process. The image data, which has been subjected to the dithering, is converted to an analog signal, as needed, by the digital-to-analog converter 1700, and then sent to the display device 1800.

The same process is performed also in the case of displaying image data, such as DVD content, which is stored on a DVD medium that is driven by the optical disc drive (ODD) 1510.

As described above, in ordinary cases, the image process is performed mainly in the 8-bit format in the computer, but the 8-bit format is converted to the 6-bit format at the output stage of the display controller 1600. Using the reduced 2 bits, the dithering is executed. Although an 8-bit equivalent gradation expression is realized by the dithering, the maximum expressible gradation number remains an 8-bit equivalent gradation number for each of R, G and B.

By applying the image processing apparatus according to the present embodiment to the computer, it becomes possible to make less visible the stripe pattern (contouring) on an image part with a gently varying gradation, and minute noise components, which occur due to roughness in the conventional quantization.

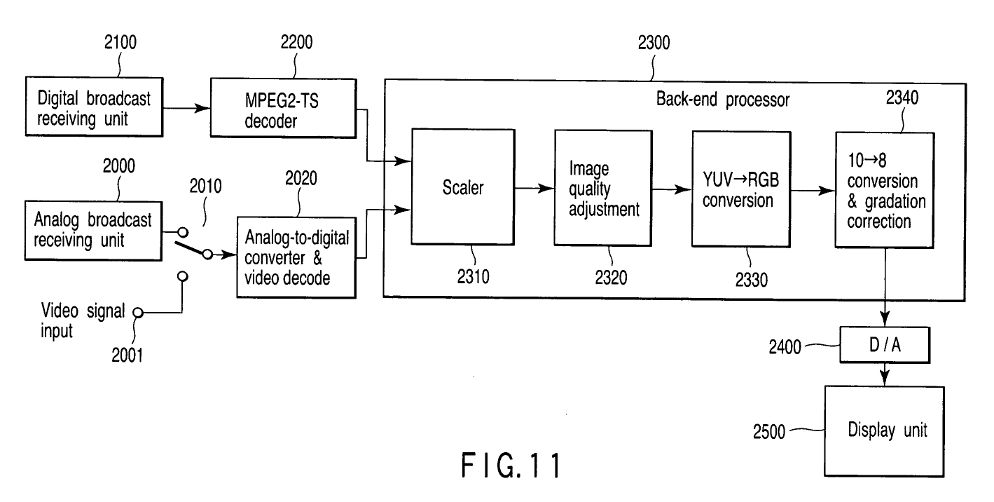

Next, referring to FIG. 11, a description is given of the flow of image data in a TV receiver to which the image processing apparatus of the present embodiment is applied.

The TV receiver includes an analog broadcast receiving unit 2000, an external video signal input unit 2001, a switch 2010, an analog-to-digital conversion & video decoder circuit 2020, a digital broadcast receiving unit 2100, an MPEG2-TS decoder circuit 2200, a back-end processor 2300, a digital-to-analog converter 2400, and a display unit 2500.

The switch 2010 selects one of a video signal included in a broadcast signal which is received by the analog broadcast receiving unit 2000, and a video signal which is input from outside to the external video signal input unit 2001. The selected video signal is delivered to the analog-to-digital & video decoder circuit 2020. The analog-to-digital & video decoder circuit 2020 converts the input video signal to a YUV-format baseband signal (digital image data). The image data obtained by the analog-to-digital & video decoder circuit 2020 is sent to the back-end processor 2300.

A digital broadcast signal which is received by the digital broadcast receiving unit 2100 is decoded by the MPEG2-TS decoder circuit 2200. Image data obtained by the decoding process is sent to the back-end processor 2300.

In the back-end processor 2300, the image size of the image data is adjusted by a scaler circuit 2310, and the image quality of the image data is adjusted by an image quality adjusting circuit 2320. Then, the image data is converted from YUV data to RGB data by a YUV-RGB conversion circuit 2330. The RGB data is composed of, e.g., 30 bits per pixel (10 bits for each of R, G and B). The RGB-format image data is delivered to a 10→8 conversion & gradation correction circuit 2340. In the 10→8 conversion & gradation correction circuit 2340, the image data is converted from the data format of 10 bits for each of R, G and B per pixel to a data format of 8 bits for each of R, G and B, and then the gradation of the image data is corrected by a frame rate control (FRC) process. The gradation-corrected image data is converted to an analog signal, as needed, by the digital-to-analog converter 2400, and then sent to the display unit 2500.

As described above, in ordinary cases, the image process is performed mainly in the 10-bit format in the TV receiver, but the 10-bit format is converted to the 8-bit format at the output stage. Using the reduced 2 bits, the FRC is executed. Although a 10-bit equivalent gradation expression is realized by the FRC, the maximum expressible gradation number remains a 10-bit equivalent gradation number for each of R, G and B.

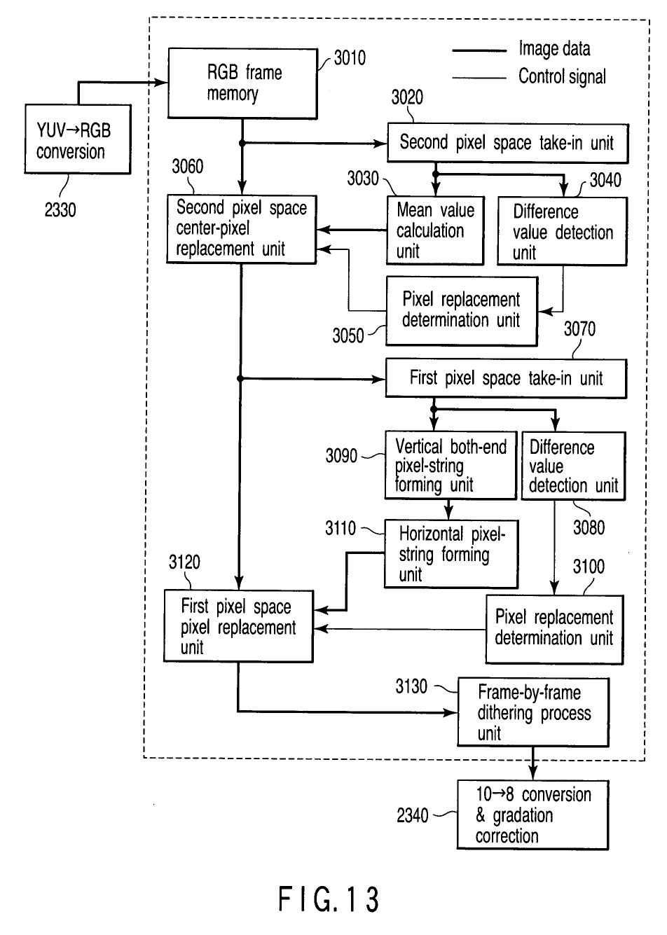

By applying the image processing apparatus according to the present embodiment to the TV receiver, it becomes possible to make less visible the stripe pattern (contouring) on an image part with a gently varying gradation, and minute noise components, which occur due to roughness in the conventional quantization. An example of the structure of the image processing apparatus, which is applied to the TV receiver, will be described later with reference to FIG. 13.

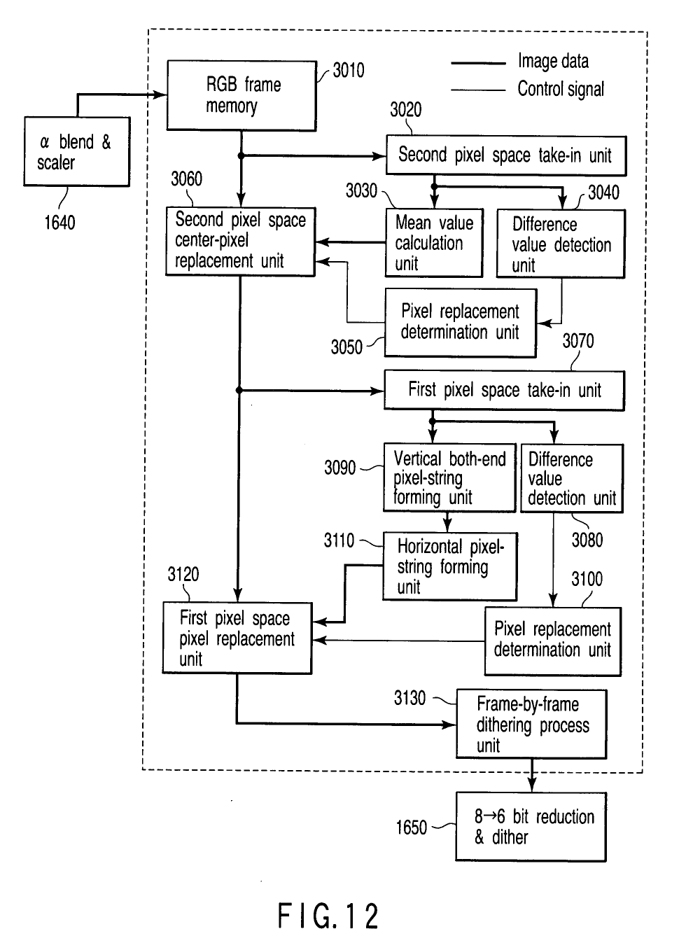

FIG. 12 shows an example of the concrete structure of the image processing apparatus which is applied to the computer shown in FIG. 10.

As is shown in FIG. 12, the image processing apparatus is provided, for example, between the blend & scale circuit 1640 and the 8→6-bit reduction & dither circuit 1650 within the display controller 1600. Although the image data is composed of three kinds of signals, i.e., signals of RGB, the image data will be described here as being composed of a single signal for the purpose of simple description.

The image processing apparatus includes an RGB frame memory 3010, a second pixel space take-in unit 3020, a mean value calculation unit 3030, a difference value detection unit 3040, a pixel replacement determination unit 3050, a second pixel space center-pixel replacement unit 3060, a first pixel space take-in unit 3070, a difference value detection unit 3080, a vertical both-end pixel-string forming unit 3090, a pixel replacement determination unit 3100, a horizontal pixel-string forming unit 3110, a first pixel space pixel replacement unit 3120, and a frame-by-frame dithering process unit 3130.

The RGB frame memory 3010 corresponds to the image memory 11 shown in FIG. 1. The second pixel space take-in unit 3020 and mean value calculation unit 3030 correspond to the mean pixel value calculation unit 12 shown in FIG. 1. The difference value detection unit 3040, pixel replacement determination unit 3050 and second pixel space center-pixel replacement unit 3060 correspond to the first replacement unit 13 shown in FIG. 1. The first pixel space take-in unit 3070, difference value detection unit 3080, vertical both-end pixel-string forming unit 3090, pixel replacement determination unit 3100, horizontal pixel-string forming unit 3110 and first pixel space pixel replacement unit 3120 correspond to the second replacement unit 14 shown in FIG. 1. The frame-by-frame dithering process unit 3130 corresponds to the output process unit 15 shown in FIG. 1.

Image data, which is output from the α blend & scale circuit 1640, is temporarily stored in the RGB frame memory 3010. The image data that is temporarily stored in the RGB frame memory 3010 is sent to the second pixel space take-in unit 3020 and second pixel space center-pixel replacement unit 3060.

The second pixel space take-in unit 3020 divides the image data, which is stored in the RGB frame memory 3010, into a plurality of first blocks (first pixel spaces), and successively reads in, with respect to each first block to be processed, four second blocks (second pixel spaces), which have their central regions located at the four corners of the first block, from the RGB frame memory 3010. The pixels of each second block that is read in by the second pixel space take-in unit 3020 are delivered to the mean value calculation unit 3030 and difference value detection unit 3040.

The mean value calculation unit 3030 calculates a mean value (to be referred to as “mean pixel value” or “mean gradation level”) of pixel values (gradation levels) of all pixels within the second block. The calculated mean pixel value is sent to the second pixel space center-pixel replacement unit 3060.

The difference value detection unit 3040 calculates a difference value between a maximum pixel value and a minimum pixel value in the second block, and sends the calculated difference value to the pixel replacement determination unit 3050.

The pixel replacement determination unit 3050 compares the difference value, which is calculated by the difference value detection unit 3040, and the above-described first threshold value. If the difference value is less than the first threshold value, the pixel replacement determination unit 3050 sends a signal, which instructs execution of the replacement process, to the second pixel space center-pixel replacement unit 3060.

Upon receiving the signal which instructs execution of the replacement process, the second pixel space center-pixel replacement unit 3060 replaces the pixel value of each of the pixels at the central part of the second block with the mean pixel value that has been calculated by the mean value calculation unit 3030.

The image data that is output from the second pixel space center-pixel replacement unit 3060 is sent to the first pixel space take-in unit 3070 and first pixel space pixel replacement unit 3120. The first pixel space take-in unit 3070 captures pixels, which correspond to the first block to be processed, from the image data that is output from the second pixel space center-pixel replacement unit 3060. The pixels within the first block to be processed, which have been captured by the first pixel space take-in unit 3070, are delivered to the difference value detection unit 3080 and vertical both-end pixel-string forming unit 3090.

The difference value detection unit 3080 calculates a difference value between a maximum pixel value and a minimum pixel value in the first block to be processed, and sends the calculated difference value to the pixel replacement determination unit 3100.

The pixel replacement determination unit 3100 compares the difference value, which is calculated by the difference value detection unit 3080, and the above-described second threshold value. If the difference value is less than the second threshold value, the pixel replacement determination unit 3100 sends a signal, which instructs execution of the replacement process, to the first pixel space pixel replacement unit 3120.

The vertical both-end pixel-string forming unit 3090 makes use of a pixel pair of two vertically positioned pixels, which are included in the four, first to fourth, pixels located at the four corners of the first block (e.g., a pair of the first pixel and second pixel or a pair of the third pixel and fourth pixel), and calculates a substitute pixel value of each of pixels of a pixel string which is disposed between the pixels of each pixel pair. In this case, as has been described with reference to FIG. 8, the substitute pixel value of each pixel in the first pixel string, which is disposed between the first pixel and the second pixel, is calculated by performing weighted averaging between the replaced pixel value of the first pixel and the replaced pixel value of the second pixel. In addition, the substitute pixel value of each pixel in the second pixel string, which is disposed between the third pixel and the fourth pixel, is calculated by performing weighted averaging between the replaced pixel value of the third pixel and the replaced pixel value of the fourth pixel.

The horizontal pixel-string forming unit 3110 makes use of two pixels which are positioned at horizontal both ends in the first block, and calculates the substitute pixel value of each pixel in a pixel string disposed between the two pixels. In this case, as has been described with reference to FIG. 9, the substitute pixel value of each pixel in the third pixel string, which is disposed between the first pixel and the third pixel, is calculated by performing weighted averaging between the replaced pixel value of the first pixel and the replaced pixel value of the third pixel. In addition, the substitute pixel value of each pixel in the forth pixel string, which is disposed between the second pixel and the fourth pixel, is calculated by performing weighted averaging between the replaced pixel value of the second pixel and the replaced pixel value of the fourth pixel. Moreover, the substitute pixel value of each pixel in each of the fifth pixel strings, which are disposed between the first pixel string and second pixel string and extend in the horizontal direction, is calculated by performing weighted averaging between the substitute pixel value of the associated pixel in the first pixel string and the substitute pixel value of the associated pixel in the second pixel string.

Upon receiving a signal which instructs execution of the replacement process from the pixel replacement determination unit 3100, the first pixel space pixel replacement unit 3120 executes the process of replacing the pixel value of each pixel in the first block with the corresponding substitute pixel value obtained by the vertical both-end pixel-string forming unit 3090 or horizontal pixel-string forming unit 3110.

The image data that is output from the first pixel space pixel replacement unit 3120 is sent to the frame-by-frame dithering process unit 3130.

The frame-by-frame dithering process unit 3130 subjects the image data, which is input from the first pixel space pixel replacement unit 3120, to the dithering process using the dithering table that varies from frame to frame. The image data that has been subjected to the dithering process is delivered to the 8→6-bit reduction & dither circuit 1650 at the next stage.

With the above-described structure, the pixel values in the first block, which belongs to the image area with a gently varying gradation level, are replaced with the substitute pixel values that are calculated on the basis of the four mean pixel values of the four second blocks which are disposed around the first block. Therefore, a stripe pattern (contouring) and minute noise can be eliminated and a smoother gradation expression than in the prior art can be realized.

FIG. 13 shows an example of the concrete structure of the image processing apparatus which is applied to the TV receiver.

As is shown in FIG. 13, the image processing apparatus is provided, for example, between the YUV-RGB conversion circuit 2330 and 10→8 conversion & gradation correction circuit 2340 shown in FIG. 11.

The structure of the image processing apparatus is the same as that of the image processing apparatus which is applied to the computer, as described with reference to FIG. 12. Thus, the description of the structure of the image processing apparatus is omitted here.

Next, a specific example of how to calculate substitute pixel values is described.

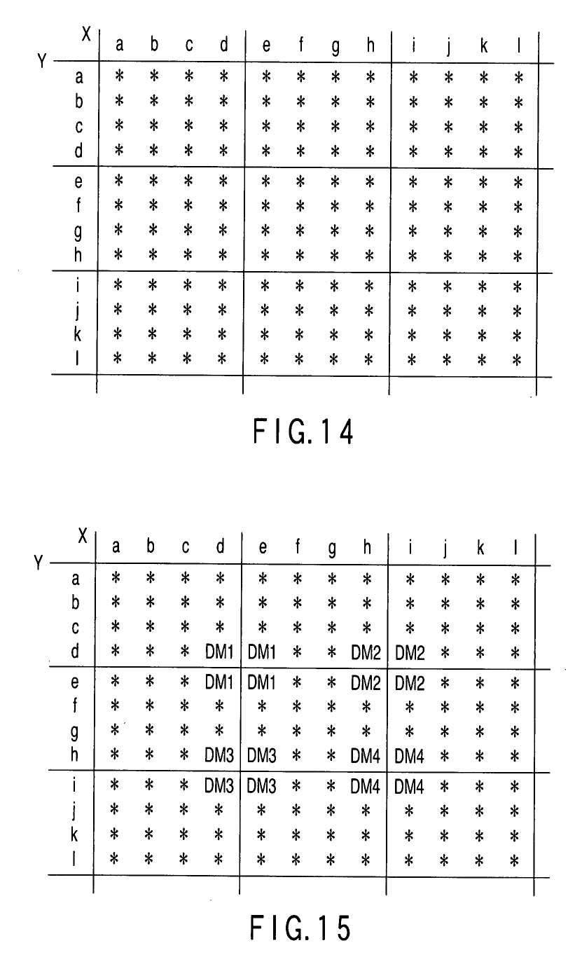

FIG. 14 shows a pixel arrangement corresponding to a plurality of first blocks. In this example, X addresses are set in the horizontal direction, and Y addresses are set in the vertical direction. The address of each pixel is expressed by (X, Y), and the pixel value of the pixel positioned at the address (X, Y) is expressed by D(X, Y). Each of the first blocks is composed of, e.g., 4×4 pixels.

Attention is now paid to a first block which is defined by (e, e), (h, e), (e, h) and (h, h). It is assumed that the difference value between the maximum and minimum values of the pixel values in the first block is less than the above-described second threshold value. In addition, it is assumed that the difference value between the maximum and minimum values of the pixel values in each of the four second blocks, which have their centers located approximately at the pixel positions of the four corners of the first block, is less than the above-described first threshold value.

Each second block is expressed by Mn (n=1, 2, 3 or 4) and the mean pixel value in the Mn is expressed by DMn. In this case, the relationship between the positions of the four second blocks and the mean pixel values is as follows:

M1 is an area surrounded by (a, a), (h, a), (a, h) and (h, h), and the mean pixel value is DM1,

M2 is an area surrounded by (e, a), (l, a), (e, h) and (l, h), and the mean pixel value is DM2,

M3 is an area surrounded by (a, e), (h, e), (a, l) and (h, l), and the mean pixel value is DM3, and

M4 is an area surrounded by (e, e), (l, e), (e, l) and (l, l), and the mean pixel value is DM4.

As shown in FIG. 15, the pixel values of the four central pixels of the second block M1 are replaced with the mean pixel value DM1. The pixel values of the four central pixels of the second block M2 are replaced with the mean pixel value DM2. The pixel values of the four central pixels of the second block M3 are replaced with the mean pixel value DM3. The pixel values of the four central pixels of the second block M4 are replaced with the mean pixel value DM4.

Next, the pixel values of the pixels in the two vertical pixel strings, which are positioned at both right and left ends in the first block surrounded by (e, e), (h, e), (e, h) and (h, h), are replaced. The substitute pixel values for the respective pixels are calculated by the following arithmetic equations:
D(e,f)=(DM1×2+DM3)÷3
D(e,g)=(DM1+DM3×2)÷3
D(h,f)=(DM2×2+DM4)÷3
D(h,g)=(DM2+DM4×2)÷3.

Subsequently, using the already calculated substitute pixel values of the two associated pixels in the pixel strings at both right and left ends, the pixel values of the pixels in each horizontal pixel string are replaced. The substitute pixel values for the respective pixels are calculated by the following arithmetic equations:
D(f,e)=(DM1×2+DM2)÷3
D(g,e)=(DM1+DM2×2)÷3
D(f,f)=(D(e,f)×2+D(h,f))÷3
D(g,f)=(D(e,f)+D(h,f)×2)÷3
D(f,g)=(D(e,g)×2+D(h,g))÷3
D(g,g)=(D(e,g)+D(h,g)×2)÷3
D(f,h)=(DM3×2+DM4)÷3
D(g,h)=(DM3+DM4×2)÷3

Thus, the pixel values of all pixels in the first block surrounded by (e, e), (h, e), (e, h) and (h, h) have been replaced.

Alternatively, the horizontal pixel string may first be formed, and then the vertical pixel string may be formed.

Thereafter, the frame-by-frame dithering process is executed by the frame-by-frame dithering process unit 3130.

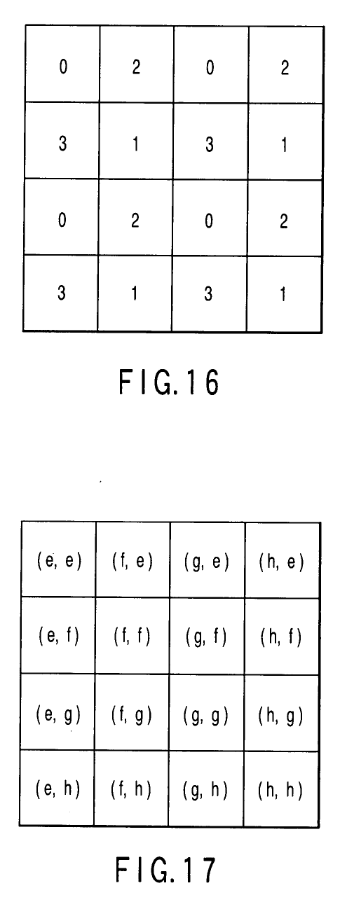

In the frame-by-frame dithering process, a dithering process is executed on each of the first blocks which have been subjected to the pixel value replacement process. In the dithering process, a 4×4 dither table, for example, as shown in FIG. 16, is used. FIG. 17 shows pixel positions of the 16 pixels in the first block, which are to be compared with 16 values in the dither table shown in FIG. 16. FIG. 17 shows, by way of example, the first block that is surrounded by (e, e), (h, e), (e, h) and (h, h).

In the frame-by-frame dithering process, low-order two bits of the replaced pixel value of each pixel in the first block is compared with the corresponding value in the dither table. If the value of the low-order two bits is greater than the corresponding value in the dither table, the value of the high-order bit part of the replaced pixel value is incremented by one. On the other hand, if the value of the low-order two bits is not greater than the corresponding value in the dither table, the value of the high-order bit part of the replaced pixel value is unchanged.

The value of the high-order bit part of the pixel value of each pixel is delivered, as a dithering process result, to the above-described 8→6-bit reduction & dither circuit 1650 or 10→8 conversion & gradation correction circuit 2340. It is thus necessary that the value of each pixel, which is output from the frame-by-frame dithering process unit 3130, be 8 bits in the computer and 10 bits in the TV receiver. Therefore, it would be convenient if the pixel value that is input to the frame-by-frame dithering process unit 3130 is 10 bits in the computer and 12 bits in the TV receiver.

Taking the above into account, the following process is executed in the present embodiment.

Normally, the mean pixel value of each second block is obtained by dividing the sum of pixel values of 64 pixels in the second block by 64. In the embodiment, however, the sum of pixel values of 64 pixels is divided by 16, and not by 64. Accordingly, the replaced pixel value DMn becomes four times greater than the normally obtained value. In other words, the bit number of the DMn increases by two bits, compared to the normally obtained value. Accordingly, if the original bit number of each pixel is 8 bits, the bit number of the DMn becomes 10 bits. If the original bit number of each pixel is 10 bits, the bit number of the DMn becomes 12 bits. The dithering process is executed by using the low-order two bits of the DMn. If the value of the low-order two bits is greater than the corresponding value in the dither table, the value of the high-order bit part (8 bits or 10 bits) of the DMn is incremented by one. On the other hand, if the value of the low-order two bits is not greater than the corresponding value in the dither table, the value of the high-order bit part (8 bits or 10 bits) of the DMn is unchanged.

By the above-described process, the image data with 8 bits per pixel can be delivered as the dithering process result to the 8→6-bit reduction & dither circuit 1650 in the computer, and the image data with 10 bits per pixel can be delivered as the dithering process result to the 10→8 conversion & gradation correction circuit 2340 in the TV receiver.

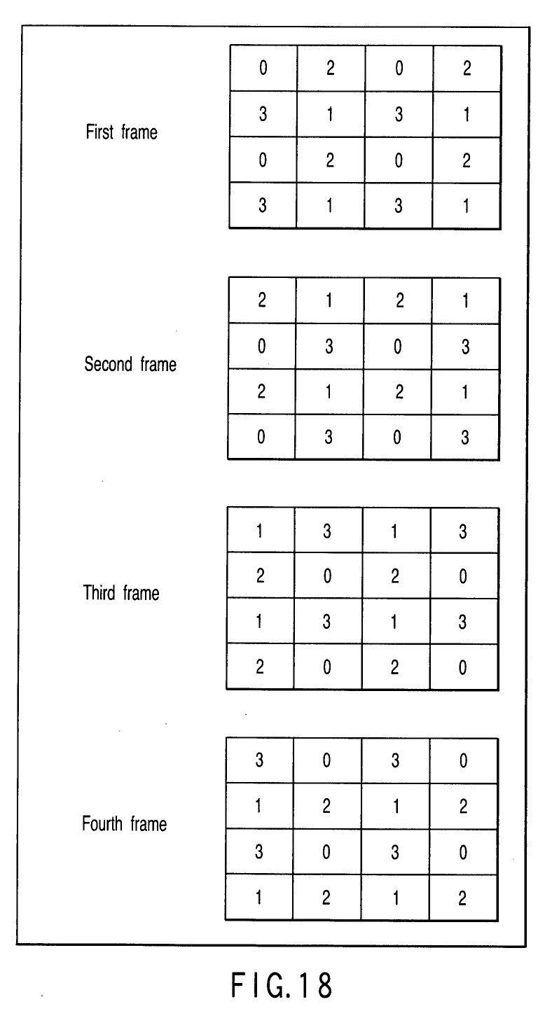

As shown in FIG. 18, the pattern of the dither table that is used is altered on a frame-by-frame basis every cycle of 4 frames. The four kinds of dither patterns shown in FIG. 18 are obtained by rotating the dither table shown in FIG. 16 in units of 90°.

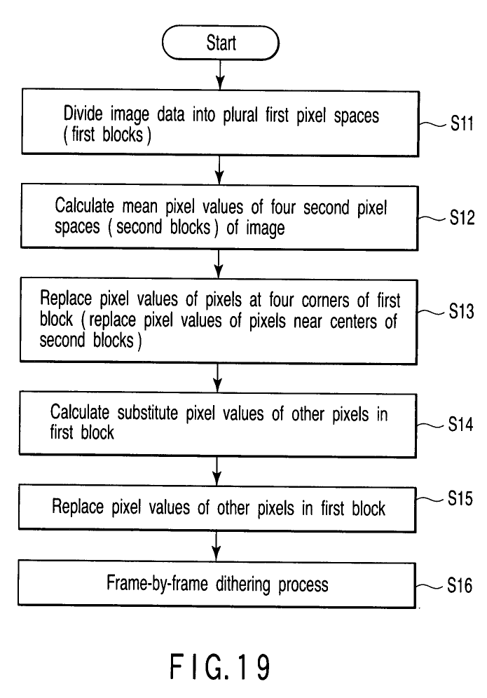

Next, referring to a flowchart of FIG. 19, the procedure of the image process according to the present embodiment is described.

To start with, the image processing apparatus divides a whole input image into a plurality of first blocks each comprising, e.g., 4×4 pixels (block S11), and executes the following process on each of the first blocks.

The image processing apparatus calculates four mean pixel values corresponding to four second blocks which have their central regions located at the four corners of the first block to be processed (block S12). If the difference value between a maximum pixel value and a minimum pixel value in each of the four second blocks is less than the first threshold value, the image processing apparatus replaces the pixel values of the four, first to fourth; pixels, which are located at the four corners of the first block to be processed, with the four mean pixel values (block S13).

Then, the image processing apparatus calculates, on the basis of the replaced pixel values (post-replacement substitute pixel values) of the four, first to fourth, pixels, substitute pixel values corresponding to the other pixels in the first block to be processed, excluding the first to fourth four pixels (block S14). If the difference value between a maximum pixel value and a minimum value in the first block to be processed is less than the second threshold value, the image processing apparatus replaces the pixel values of the other pixels in the first block to be processed, excluding the first to fourth four pixels, with the corresponding substitute pixel values (block S15). In the process of calculating the difference value between the maximum and minimum values in the first block to be processed, a process is executed to detect a maximum and a minimum value of 16 pixel values in the first block to be processed. In this detection process, the replaced pixel values (post-replacement substitute pixel values) or the pre-replacement original pixel values may be used as the pixel values of the four (first to fourth) pixels.

The above-described process is executed for each of all the first blocks. Thereafter, the image processing apparatus subjects the image data corresponding to each first block to the dithering process using the dithering table that varies from frame to frame (block S16).

As has been described above, according to the present embodiment, it is possible to make less visible the stripe pattern (contouring) on an image part with a gently varying gradation, and minute noise components, which occur due to roughness in the conventional quantization. Moreover, a finer gradation expression can be realized by the frame-by-frame dithering process.

With reference to FIGS. 12 and 13, descriptions have been given of the examples in which the image processing apparatus according to the embodiment is interposed between the circuits which handle RGB data. Alternatively, the image processing apparatus according to the embodiment may be interposed between circuits which handle YUV data. In addition, the image data, which is obtained by the image processing apparatus according to the embodiment, may be output to the display device without intervention of the 8→6-bit reduction & dither circuit 1650 or the 10→8 conversion & gradation correction circuit 2340. Besides, the frame-by-frame dithering process may be omitted.

In the present embodiment, each of the second blocks is composed of four neighboring first blocks. Alternatively, each of the second blocks may be composed of, for example, eight neighboring first blocks. In addition, the pixel values of all pixels (including four corner pixels) in the first block may be calculated on the basis of mean pixel values of four second blocks which have their central regions located at the four corners of the first block.

All the image processes which are executed by the image processing apparatus according to the present embodiment may be executed by software. Thus, the same advantageous effects as with the present embodiment can easily be obtained simply by installing a computer program, which causes a computer to execute the procedure of the image processes of the embodiment, into an ordinary computer through a computer-readable storage medium.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image processing apparatus which generates output image data, which is to be output to a display device, from input image data, comprising:
a mean pixel value calculation unit which divides the input image data into a plurality of first blocks, and calculates four mean pixel values corresponding to four second blocks which have central regions located at four corners of the first block to be processed;
a first replacement unit which replaces, if a difference value between a maximum pixel value and a minimum pixel value in each of the four second blocks is less than a first threshold value, pixel values of four, first to fourth, pixels, which are located at the four corners of the first block to be processed, with the four mean pixel values;
a substitute pixel value calculation unit which calculates substitute pixel values corresponding to pixels in the first block to be processed, on the basis of the replaced pixel values of the four, first to fourth, pixels; and
a second replacement unit which replaces, if a difference value between a maximum pixel value and a minimum pixel value in the first block to be processed is less than a second threshold value, pixel values of the pixels in the first block to be processed with the corresponding substitute pixel values calculated by the substitute pixel value calculation unit.

2. The image processing apparatus according to claim 1, wherein a number of pixels included in each of the four second blocks is greater than a number of pixels included in each of the first blocks.

3. The image processing apparatus according to claim 1, wherein each of the four second blocks includes four or more said first blocks, and one of the four or more first blocks is the first block to be processed.

4. The image processing apparatus according to claim 1, further comprising means for subjecting the output image data corresponding to the first block to be processed, which is generated by the first replacement unit and the second replacement unit, to a dithering process using a dither table which varies from frame to frame.

5. An image processing apparatus which generates output image data, which is to be output to a display device, from input image data, comprising:
a mean pixel value calculation unit which divides the input image data into a plurality of first blocks, and calculates four mean pixel values corresponding to four second blocks which have central regions located at four corners of the first block to be processed;
a first replacement unit which replaces, if a difference value between a maximum pixel value and a minimum pixel value in each of the four second blocks is less than a first threshold value, pixel values of first, second, third and fourth pixels, which are located at the four corners of the first block to be processed, with the four mean pixel values, the first pixel and the fourth pixel being located on a diagonal of the first block to be processed, the second pixel and the third pixel being located on another diagonal of the first block to be processed; and
a second replacement unit which executes a pixel value replacement process if a difference value between a maximum pixel value and a minimum pixel value in the first block to be processed is less than a second threshold value, the pixel value replacement process including:
a process of replacing pixel values of pixels in a first pixel string, which is disposed between the first pixel and the second pixel, with values which are obtained by performing weighted averaging between the replaced pixel value of the first pixel and the replaced pixel value of the second pixel,
a process of replacing pixel values of pixels in a second pixel string, which is disposed between the third pixel and the fourth pixel, with values which are obtained by performing weighted averaging between the replaced pixel value of the third pixel and the replaced pixel value of the fourth pixel,
a process of replacing pixel values of pixels in a third pixel string, which is disposed between the first pixel and the third pixel, with values which are obtained by performing weighted averaging between the replaced pixel value of the first pixel and the replaced pixel value of the third pixel,
a process of replacing pixel values of pixels in a fourth pixel string, which is disposed between the second pixel and the fourth pixel, with values which are obtained by performing weighted averaging between the replaced pixel value of the second pixel and the replaced pixel value of the fourth pixel, and
a process of replacing pixel values of pixels in each of fifth pixel strings, which are disposed between the first pixel string and the second pixel string and extend in a direction perpendicular to the first pixel string, with values which are obtained by performing weighted averaging between the replaced pixel value of the associated pixel in the first pixel string and the replaced pixel value of the associated pixel in the second pixel string.

6. The image processing apparatus according to claim 5, wherein a number of pixels included in each of the four second blocks is greater than a number of pixels included in each of the first blocks.

7. The image processing apparatus according to claim 5, wherein each of the four second blocks includes four or more said first blocks, and one of the four or more first blocks is the first block to be processed.

8. An image processing method for generating output image data, which is to be output to a display device, from input image data, comprising:
dividing the input image data into a plurality of first blocks, and calculating four mean pixel values corresponding to four second blocks which have central regions located at four corners of the first block to be processed;
replacing, if a difference value between a maximum pixel value and a minimum pixel value in each of the four second blocks is less than a first threshold value, pixel values of four, first to fourth, pixels, which are located at the four corners of the first block to be processed, with the four mean pixel values;
calculating substitute pixel values corresponding to pixels in the first block to be processed, on the basis of the replaced pixel values of the four, first to fourth, pixels; and
replacing, if a difference value between a maximum pixel value and a minimum pixel value in the first block to be processed is less than a second threshold value, pixel values of the pixels in the first block to be processed with the corresponding substitute pixel values which are calculated.

9. The image processing method according to claim 8, wherein a number of pixels included in each of the four second blocks is greater than a number of pixels included in each of the first blocks.

10. The image processing method according to claim 8, wherein each of the four second blocks includes four or more said first blocks, and one of the four or more first blocks is the first block to be processed.
